(19) United States
(12) Patent Application Publication
(10) Pub. No.: US 2014/0258372 A1
(43) Pub. Date: Sep. 11, 2014

(54) Systems and Methods for Categorizing and Measuring Engagement with Content

(71) Applicant: SAY MEDIA, INC, San Francisco, CA (US)

(72) Inventors: David Lerman, San Francisco, CA (US); Benjamin Trott, San Francisco, CA (US); Sarah Betts, San Francisco, CA (US); Jason Michael, San Francisco, CA (US); Aida Tavakkolie, San Francisco, CA (US)

(73) Assignee: Say Media, Inc, San Francisco, CA (US)

(21) Appl. No.: 13/792,855

(22) Filed: Mar. 11, 2013

(51) Int. Cl. H04L 29/06

(52) U.S. Cl. CPC H04L 67/42
USPC 709/203

(57) ABSTRACT

Systems and methods for engagement tracking devices configured to track engagement with content having one or more activity zones in accordance with embodiments of the invention are disclosed. In one embodiment, an engagement tracking device includes a processor and an engagement tracking application, wherein the engagement tracking application configures the processor to display content, where the displayed content includes data defining one or more activity zones within the displayed content, receive input data based on user input received via an input device configured to receive user input, where the input data is associated with one or more activity zones within the content, generate engagement data based on the received input data, where the engagement data includes the received input data and identified the associated activity zone, and transmit the engagement data to an engagement processing server system as the engagement data is generated.

### FIELD OF THE INVENTION

The present invention relates to systems and methods for engagement tracking and more specifically to tracking engagement with content.

### BACKGROUND

The Internet is a global system of interconnected computer networks. A variety of services are provided on the Internet, including websites. Websites include a variety of content, such as text, pictures, audio data, video data, and other interactive content. Web sites are typically hosted using content servers and a web browser is an application that enables a user to receive, view, and interact with a websites hosted on content servers. A variety of web browsers are commonly used to view websites, including Internet Explorer from Microsoft Corporation of Redmond, Wash. and the Chrome browser from Google, Inc. of Mountain View, Calif.

Many documents, including web pages within a website, are often written using the Hypertext Markup Language (HTML). A HTML document contains a set of nested tags. HTML tags include data stored in the tag, either as a property of the tag or between an opening tag and a closing tag. Web browsers do not display the HTML tags; rather, web browsers are configured to parse a HTML document and render one or more web pages including the information stored in the HTML tags.

Cascading Style Sheets (CSS) are used to describe the formatting and display of a document when it is rendered. CSS can be used to describe the formatting of a variety of documents, including HTML documents and other documents, such as documents written using the Extensible Markup Language (XML). A single document can have a variety of associated CSS, so that the document can be rendered in a variety of ways depending on the capabilities of the device used to display the document. For example, a HTML document can be rendered with one format in a web browser on a desktop computer using a CSS designed for a desktop browser, while the same HTML document can be rendered in a second format in a web browser running on a mobile phone using a second CSS designed for a mobile browser.

The Document Object Model (DOM) is a standard defined by the Word Wide Web Consortium that defines the creation of an in-memory object model corresponding to data contained in documents, including HTML and XML documents. These objects are stored in a DOM tree and are utilized by web browsers to render and manipulate documents. When a HTML document is rendered in a web browser, the browser parses the HTML and creates an in-memory DOM that is used to display the HTML document. Web browsers contain one or more layout engines configured to create a DOM from a document. Many layout engines are used today, including the open-source WebKit layout engine utilized by the Chrome browser and the Apple Safari browser from Apple, Inc. of Cupertino, Calif. and the Trident layout engine used in Internet Explorer.

Many web pages utilize scripts in order to provide flexibility in the creation and display of a web page. Scripts can be written in a variety of languages, including JavaScript by the Mozilla Foundation of Mountain View, Calif. and ECMAScript, standardized as ECMA-262 by ECMA International of Geneva, Switzerland. Web browsers are configured to parse and execute scripts contained in web pages. These scripts can control the appearance of a web page, customize the content according to the preferences of a user viewing the web page, and allow for data to be received using the web page. Scripts can be server-side, where the script is run on a content server, or client-side, where the script is run using the web browser receiving the script.

### SUMMARY OF THE INVENTION

Systems and methods for engagement tracking devices configured to track engagement with content having one or more activity zones in accordance with embodiments of the invention are disclosed. In one embodiment an engagement tracking device includes a processor, a memory configured to store an engagement tracking application, and content storage configured to store content, where the content includes data defining one or more activity zones within the content, wherein the engagement tracking application configures the processor to display the content via a display device configured to display content, where the displayed content includes one or more activity zones, receive input data based on user input received via an input device configured to receive user input, where the input data is associated with one or more activity zones within the content, generate engagement data based on the received input data, where the engagement data includes the received input data and identified the associated activity zone, and transmit the engagement data to an engagement processing server system as the engagement data is generated.

In an additional embodiment of the invention, the engagement processing server system is configured to obtain a plurality of pieces engagement data from at least one engagement tracking device, categorize a portion of the pieces of engagement data based on the received input data and the associated activity zone within the pieces of engagement data, and identify engagement trends within the pieces of engagement data based on the categorized portion of the pieces of engagement data.

In another embodiment of the invention, the engagement processing server system is further configured to identify session data for a portion of the pieces of engagement data, where the session data identifies the portion of the pieces of engagement data as being related across a browsing session and identify engagement trends based on the categorized portion of the pieces of engagement data and the session data.

In yet another additional embodiment of the invention, the engagement processing server system is further configured to correlate a portion of the pieces of engagement data, where the correlated pieces of engagement data include different pieces of received input data that are determined to be similar based on the engagement tracking device receiving the input data.

In still another additional embodiment of the invention, the engagement tracking application further configures the processor to aggregate a plurality of pieces of received input data, where the plurality of pieces of received input data are identified as being part of the same interaction with an activity zone and generate a piece of engagement data based on the aggregated input data.

In yet still another additional embodiment of the invention, the input data further includes a timestamp indicating the time associated with the receipt of the input data and the generated engagement data further includes the timestamp.

In yet another embodiment of the invention, the engagement tracking application further configures the processor to categorize the engagement data based on the received input data, the activity zone associated with the input data, and the timestamp.

In still another embodiment of the invention, the engagement tracking application further configures the processor to aggregate the input data based on the timestamp associated with the input data.

In yet still another embodiment of the invention, the engagement tracking application further configures the processor to display the content based on the capabilities of the engagement tracking device.

In yet another additional embodiment of the invention, the engagement tracking application further configures the processor to categorize the engagement data based on engagement categorization data, where the engagement categorization data includes a predefined set of activity zones associated with a predefined set of input data.

Yet another embodiment of the invention includes a method for tracking engagement with a content including displaying content using an engagement tracking device, where the displayed content includes one or more activity zones, receiving input data based on user input using the engagement tracking device, where the input data is associated with one or more activity zones within the content, generating engagement data based on the received input data using the engagement tracking device, where the engagement data includes the received input data and identified the associated activity zone, and transmitting the engagement data to an engagement processing server system as the engagement data is generated using the engagement tracking device.

In yet another additional embodiment of the invention, the engagement processing server system is configured to obtain a plurality of pieces engagement data from at least one engagement tracking device, categorize a portion of the pieces of engagement data based on the received input data and the associated activity zone within the pieces of engagement data, and identify engagement trends within the pieces of engagement data based on the categorized portion of the pieces of engagement data.

In still another additional embodiment of the invention, the engagement processing server system is further configured to identify session data for a portion of the pieces of engagement data, where the session data identifies the portion of the pieces of engagement data as being related across a browsing session, and identify engagement trends based on the categorized portion of the pieces of engagement data and the session data.

In yet still another additional embodiment of the invention, the engagement processing server system is further configured to correlate a portion of the pieces of engagement data, where the correlated pieces of engagement data include different pieces of received input data that are determined to be similar based on the engagement tracking device receiving the input data.

In yet another embodiment of the invention, tracking engagement with content further includes aggregating a plurality of pieces of received input data using the engagement tracking device, where the plurality of pieces of received input data are identified as being part of the same interaction with an activity zone and generating a piece of engagement data based on the aggregated input data using the engagement tracking device.

In still another embodiment of the invention, the input data further includes a timestamp indicating the time associated with the receipt of the input data and the generated engagement data further includes the timestamp.

In yet still another embodiment of the invention, tracking engagement with content further includes categorizing the engagement data based on the received input data, the activity zone associated with the input data, and the timestamp using the engagement tracking device.

In yet another additional embodiment of the invention, tracking engagement with content further includes aggregating the input data based on the timestamp associated with the input data using the engagement tracking device.

In still another additional embodiment of the invention, tracking engagement with content further includes displaying the content based on the capabilities of the engagement tracking device using the engagement tracking device.

In yet still another additional embodiment of the invention, tracking engagement with content further includes categorizing the engagement data based on engagement categorization data using the engagement tracking device, where the engagement categorization data includes a predefined set of activity zones associated with a predefined set of input data.

### BRIEF DESCRIPTION OF THE DRAWINGS

FIG. 1 conceptually illustrates an engagement tracking system including an engagement tracking device in accordance with an embodiment of the invention.

FIG. 2 is a conceptual illustration of an engagement tracking device in accordance with an embodiment of the invention.

FIG. 3 is a flow chart illustrating a process for receiving and transmitting engagement data in accordance with an embodiment of the invention.

FIG. 4 is a flow chart illustrating a process for identifying engagement trends in accordance with an embodiment of the invention.

### DETAILED DESCRIPTION

Turning now to the drawings, systems and methods for tracking engagement with content having one or more activity zones in accordance with embodiments of the invention are illustrated. Engagement tracking devices are configured to display content having one or more activity zones within the content. Content includes web pages, advertisements, video content, applications, games, and any other content as appropriate to the requirements of specific applications in accordance with embodiments of the invention. In a variety of embodiments, engagement tracking devices utilize web browsers and/or other content display applications to display and interact with content. When displaying content (such as web pages), engagement tracking devices receive input to control the portions of the content that are displayed and to map the received input to the displayed content to enable interaction with the activity zones within the content. In several embodiments, the input is mapped to actions or events that are generated by a web browser, scripts associated with the content, and/or the operating system of the engagement tacking device. Engagement tracking devices are further configured to track the mapped input; the tracked input can be utilized to determine the type and/or duration of engagement with the displayed content. Engagement data includes the tracked input along with metadata describing the context and/or properties of the tracked input, including the type of input, the activity zone associated with the input, and a timestamp identifying the time the input was received. Engagement data can include a variety of other data not specifically described as appropriate to the requirements of specific applications in accordance with embodiments of the invention. In certain embodiments, engagement tracking devices are configured to aggregated input and create engagement data based on the aggregated input. In several embodiments, engagement tracking devices are configured to transmit engagement data to an engagement tracking server system. The engagement data can be transmitted as it is generated (e.g. as the input data is received) and/or transferred in bulk as appropriate to the requirements of specific applications in accordance with embodiments of the invention. Engagement tracking server systems are configured to receive one or more pieces of engagement data from one or more engagement tracking devices for one or more pieces of content and determine engagement trends within the received engagement data.

Engagement data can be analyzed as atomic pieces of data and/or categorized and/or aggregated to analyze trends occurring across multiple pieces of engagement data. Engagement data can be categorized based on the activity zone the input occurs in and/or the type of input that is utilized to perform the engagement with the content. The categorization can be performed by the engagement tracking device and/or an engagement tracking server system configured to receive engagement tracking data from the engagement tracking device. In many embodiments, engagement tracking devices and/or engagement tracking server systems are configured to analyze engagement data from one or more pieces of content to determine trends within the engagement data. The analyzed engagement data can be associated with one or more pieces of content. In a variety of embodiments, several pieces of content are associated with each other and are viewed and interacted within a single browsing session. In many embodiments, engagement data is analyzed for the pieces of content viewed and interacted within multiple browsing sessions. In several embodiments, a session includes viewing related pieces of content across multiple engagement tracking devices. Other sessions can be utilized in the determination of trends within sets of engagement data as appropriate to the requirements of specific applications in accordance with embodiments of the invention.

Engagement tracking devices include computers running web browsers configured to display hypertext markup language (HTML) web pages using cascading style sheets (CSS) and one or more scripts using a document object model (DOM) representing the web page. In a number of embodiments, the CSS are used to define the HTML defining the web page and the CSS are utilized to define and style the content and/or the activity zones. In several embodiments, the scripts are configured to modify the content of the web page/and or directly modify the DOM model representing the web page in the web browser. In a variety of embodiments, tracking engagement with one or more activity zones within the content includes tracking modifications to the DOM model. These scripts can be contained in one or more files included in the web page and/or included inline in the web page. The scripts can be written in any scripting language known to one of ordinary skill in the art including, but not limited to, JavaScript and ECMAScript.

Although engagement tracking devices configured to generate engagement data based on interactions with content having one or more activity zones are described above with respect to HTML, CSS, and JavaScript, any variety of techniques can be utilized in accordance with embodiments of the invention. Systems and methods for capturing and analyzing engagement data in accordance with embodiments of the invention are described below.

### Engagement Tracking System Overview

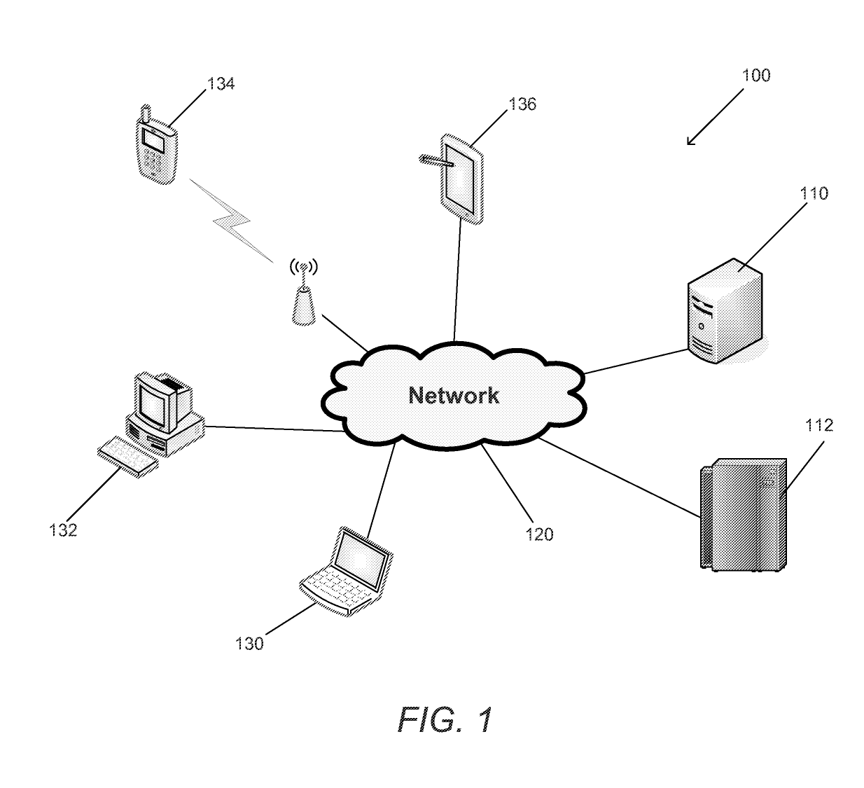

Engagement tracking systems in accordance with embodiments of the invention are configured to receive interactions with content, create engagement data using the received interactions, and analyze the engagement data to determine trends within the interactions with the content. An engagement tracking system in accordance with an embodiment of the invention is conceptually illustrated in FIG. 1. The engagement tracking system 100 includes a content server 110 connected to one or more engagement tracking devices via a network 120. The engagement tracking system 100 also contains an engagement tracking server system 112 connected to the engagement tracking devices and the content server 110 via the network 120. Engagement tracking devices include laptop computers 130, personal computers 132, cellular telephones 134, and tablet devices 136. Other engagement tracking devices such as televisions, wearable computers, and gaming consoles can be utilized as appropriate to the requirements of specific applications in accordance with embodiments of the invention. In several embodiments, the content server 110 and/or the engagement tracking server system 112 are implemented using a single server. In a number of embodiments, the content server 110 and/or the engagement tracking server system 112 are implemented using a plurality of servers. In many embodiments, the network 120 is the Internet.

The engagement tracking devices are configured to receive content having one or more activity zones from the content server 110, generate engagement data based on interactions with the received content, and transmit engagement data to the engagement tracking server system 112. In a variety of embodiments, the content contains at least one script configured to track interactions with one or more activity zones within the content and/or create engagement data based on the tracked interactions and the activity zones associated with the tracked interactions. Interactions include, but are not limited to, mouse movements, mouse clicks, key presses, touch interactions, swipe interactions, rotation interactions, and voice input. In several embodiments, idle time is tracked, where idle time is calculated by determining the amount of time the content is displayed relative to the amount of time interactions are being tracked with respect to the content. Activity zones are any portion of the content including one or more content elements such as text data, video data, audio data, image data, comment content, advertising content, navigation content, and links (or other references) to other pieces of content. Other interactions, activity zones, and content elements not specifically described can be utilized as appropriate to the requirements of specific applications in accordance with embodiments of the invention. In a variety of embodiments, the engagement tracking devices are configured to aggregate interaction data and generate a piece of engagement data containing the aggregated interaction data. In many embodiments, the display of the content and/or the interaction with the content is based on the capabilities of the engagement tracking device. In a number of embodiments, the content is a web page (or a portion of a web page) including HTML elements, CSS, and/or one or more scripts and the engagement tracking devices are configured to render the received web page. In several embodiments, an engagement tracking device creates an in-memory object model, such as a DOM, as part of the rendering of the received web page. In a variety of embodiments, the engagement tracking devices are configured to track interactions with the content by monitoring the in-memory object model and/or the actual received web page for events and/or modifications resulting from the interactions with the content. In a number of embodiments, engagement tracking devices are configured to receive input for navigating and/or manipulating the rendered web page and create engagement data based on the received input and/or the activity zone(s) associated with the received input. In many embodiments, one or more of the scripts included in the content are configured to transmit the generated engagement data to the engagement tracking server system 112 continuously and/or in real-time (e.g. as the input is received and the engagement data is generated). By measuring and transmitting the generated engagement data in real-time, the time associated with the input data can be measured with an arbitrary level of accuracy, such as on a second or on a millisecond level. In a variety of embodiments, one or more of the scripts included in the content are configured to transmit the generated engagement data in bulk in response to an event, such as navigating to another piece of content, closing the displayed content, and/or after a period of time has elapsed. The events can be pre-determined and/or determined dynamically as appropriate to the requirements of specific applications in accordance with embodiments of the invention.

The engagement tracking server system 112 is configured to receive engagement data from one or more engagement tracking devices. The engagement tracking server system 112 is further configured to categorize the interactions described in the engagement data. In several embodiments, the engagement tracking server system 112 is configured to categorize interactions taken from engagement data from multiple pieces of content and/or and multiple engagement tracking devices. In a variety of embodiments, the engagement tracking server system 112 is configured to determine engagement time information using timestamp data associated with the interactions in the engagement data, where the engagement time information describes the amount of time a user is actively engaged with a piece of content and/or the amount of time the user was not actively engaged with the piece of content. The engagement tracking server system 112 is further configured to utilize the received engagement data to identify trends and/or performance data related to the interactions with the content. In this way, the engagement tracking server system 112 is capable of identifying pieces of content that encourage a high degree of user engagement and/or activity zones that could be optimized to better encourage user engagement with the content.

Although a specific engagement tracking system is conceptually illustrated in FIG. 1, alternative architectures, including those with devices in peer-to-peer communication and those where engagement tracking devices are configured to categorize and/or analyze engagement data, can also be utilized in accordance with embodiments of the invention. Systems and methods for tracking engagement with content in accordance with embodiments of the invention are discussed below.

### Engagement Tracking Devices

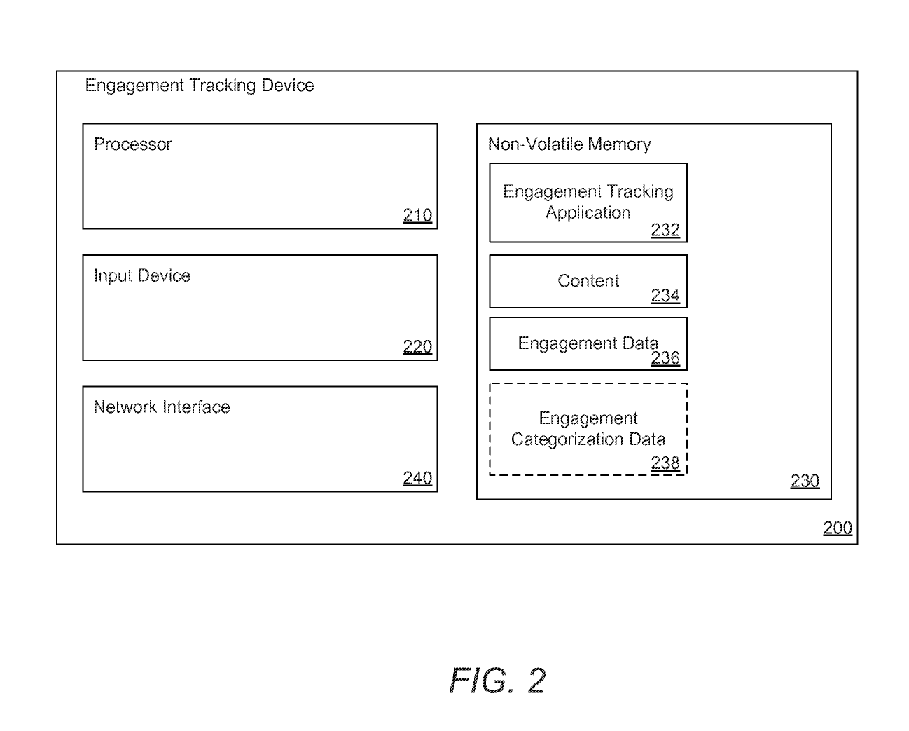

Engagement tracking devices in accordance with embodiments of the invention are configured to display content having activity zones, track interactions with the rendered content, and transmit engagement data generated based on the tracked interactions. A conceptual illustration of an engagement tracking device in accordance with an embodiment of the invention is shown in FIG. 2. The engagement tracking device 200 includes a processor 210 in communication with memory 230. The engagement tracking device 200 also includes a network interface 240 configured to send and receive data over a network connection. In a number of embodiments, the network interface 240 is in communication with the processor 210 and/or the memory 230. The engagement tracking device 200 includes an input device 220 connected to the processor 210 and/or the memory 230. The input device 220 is one or more of a variety of devices, including, but not limited to, mice, keyboards, touch screens, and cameras configured to track movement; other input devices can be utilized as appropriate to the requirements of specific applications in accordance with embodiments of the invention.

The processor 210 is configured by the engagement tracking application 232 to render content 234 having one or more activity zones. In several embodiments, the engagement tracking application 232 configures the processor 210 to generate an in-memory object model representing the content 234 and render the content for display using the in-memory object model. The engagement tracking application 232 further configures the processor 210 to receive and track input data from the input device 220 directed towards one or more of the activity zones in the rendered content. The engagement tracking application 232 configures the processor 210 to generate engagement data 236 based on the tracked input data and/or changes in the object model in response to the received input data. In a variety of embodiments, engagement data 236 includes tracked input, the activity zone in the content associated with the tracked input, and a timestamp indicating the time at which the tracked input was received. In a variety of embodiments, the engagement tracking application 232 configures the processor 210 to aggregated several pieces of input data from the input device 220 and generate a single piece of engagement data 236 including the aggregated input data, the associated activity zone, and a timestamp associated with the time the aggregated input data was generated. In many embodiments, the engagement tracking application 232 configures the processor 210 to transmit the engagement data 236 continuously and/or in real-time as the engagement data 236 is generated. In a number of embodiments, the engagement tracking application 232 configures the processor 210 to transmit the engagement data 236 in bulk, such as at the occurrence of an event (navigating away from the content and/or a certain number of pieces of engagement data have been generated) or after an interval of time; the time interval can be pre-determined and/or determined dynamically.

The engagement tracking application 232 configures the processor 210 to retrieve the content 234 for rendering and to store generated in-memory data models of web pages and/or the retrieved content for storage and later retrieval. In several embodiments, the memory 230 is any form of storage configured to store a variety of data, including, but not limited to, the engagement tracking application 232, content 234, engagement data 236, and/or engagement categorization data 238. In a variety of embodiments, the engagement tracking application 232 configures the processor to categorize engagement data 236 using engagement categorization data 238. Processes for categorizing engagement data using engagement categorization data are discussed further below.

The network interface 240 is configured to receive content 234 having activity zones, engagement data 236, and/or engagement categorization data 238 via a network (such as the Internet) and provide the received data to the processor 210 and/or the memory 230. The engagement tracking application 232 configures the processor 210 to generate requests for content 234, engagement data 236, and/or engagement categorization data 238 and transmit those requests using the network interface 240. The engagement tracking application 232 further configures the processor 210 to transmit engagement data 236 and/or engagement categorization data 238 using the network interface 240. In many embodiments, the engagement tracking application 232, the content 234, the engagement data 236, and/or the engagement categorization data 238 are stored using an external server system and received by the engagement tracking device 200 using the network interface 240.

Although a specific architecture for an engagement tracking device in accordance with an embodiment of the invention is conceptually illustrated in FIG. 2, any of a variety of architectures, including those which store data or applications on disk or some other form of storage and are loaded into memory 230 at runtime and systems that are distributed across multiple physical servers, can also be utilized in accordance with embodiments of the invention. Methods for tracking interactions with content and processing engagement data in accordance with embodiments of the invention are discussed below.

Tracking Engagement with Displayed Content

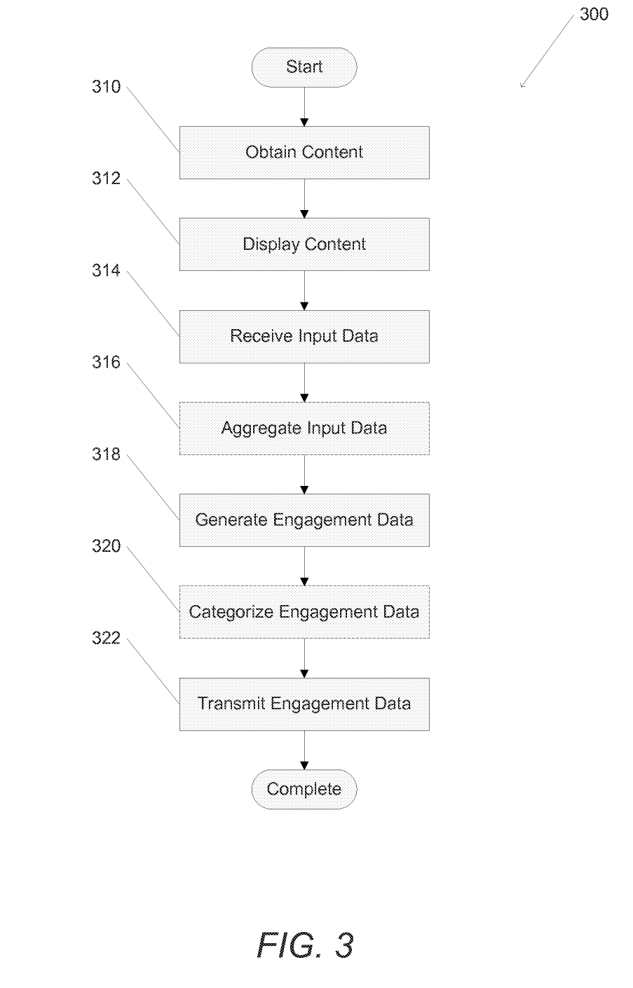

As users browse web sites, they view and interact with a variety of pieces of content. By tracking user input with content, engagement data describing the interactions with the content can be determined. The engagement data can be analyzed to determine how users engage with content. Engagement tracking devices in accordance with embodiments of the invention are configured to display content, receive input data, generate engagement data, and transmit the engagement data to remote systems for analysis. A process for tracking engagement with displayed content in accordance with an embodiment of the invention is illustrated in FIG. 3. The process 300 includes obtaining (310) content. Content is displayed (312). Input data is received (314). In a variety of embodiments, input data is aggregated (316). Engagement data is generated (318). In several embodiments, engagement data is categorized (320). Engagement data is transmitted (322).

In many embodiments, obtaining (310) content with activity zones and/or transmitting (322) engagement data utilizes the hypertext transfer protocol (HTTP) and/or a secured version of HTTP, such as HTTP Secure. HTTP is defined in RFC 2616, published by the Internet Engineering Task Force, the entirety of which is incorporated by reference. In other embodiments, any of a variety of stateless and/or stateful data transfer protocols can be utilized. In several embodiments, the obtained (310) content is a web page containing HTML, CSS, and one or more scripts. The locations of activity zones within the obtained (310) content can be indicated within the obtained (310) content (such as via identifying markup within the content) and/or within one or more of the scripts associated with the obtained (310) content. A variety of markup can be utilized in accordance with specific requirements of specific embodiments of the invention, including, but not limited to, <div> tags and/or custom HTML tags. In a variety of embodiments, the obtained (310) content has a width and a height and the activity zone(s) are indicated by one or more vertical and/or horizontal positions within the content based on the width and/or height of the content. Other techniques for identifying the position of activity zones within obtained (310) content can be utilized as appropriate to the requirements of specific applications in accordance with embodiments of the invention.

In many embodiments, displaying (312) the content includes generating an in-memory object model. In a variety of embodiments, the in-memory object model is a document object model. In many embodiments, the content is displayed (312) utilizing a display device connected to the engagement tracking device. In many embodiments, displaying (312) the content includes displaying one or more activity zones within the content. In several embodiments, the displayed (312) content is based on the capabilities of the engagement tracking device displaying (312) the content. Capabilities of an engagement tracking device include, but are not limited to, the resolution of the display associated with the engagement tracking device, the web browser or other engagement tracking application utilized by the engagement tracking device to display (312) the content, the processing capabilities of the engagement tracking device, and/or the input device(s) connected to the engagement tracking device. Any capabilities of engagement tracking devices not specifically described can be utilized as appropriate to the requirements of specific applications in accordance with embodiments of the invention.

In many embodiments, receiving (314) input data includes determining which activity zone(s) within the displayed (312) content the input data is targeted toward and/or the time at which the input data is received (314). In a number of embodiments, one or more of the activity zones are associated with third-party services, tools, content, and/or activities. For example, a third-party service can include sharing content on a social networking service, although any third-party data can be utilized as appropriate to the requirements of specific applications in accordance with embodiments of the invention. In a variety of embodiments, multiple pieces of input data are received (314) as part of one interaction with an activity zone. For example, multiple keypress events can be received (314) as input data when a user is typing a comment in a comment box activity zone. In many embodiments, aggregating (316) input data includes identifying multiple pieces of input data associated with the same interaction and generating aggregate data representing the multiple pieces of input data. In several embodiments, generating (318) engagement data utilizes the input data (or the aggregated (316) input data), the activity zone associated with the input data, and the timestamp associated with the input data. In a number of embodiments, engagement data is categorized (320) based on the data contained in the engagement data, the capabilities of the engagement tracking device generating (318) the engagement data, and/or engagement categorization data. Engagement categorization data includes a variety of sets of data, including common activity zones and input associated with the common activity zones. In several embodiments, engagement categorization data includes a set of predefined actions that are abstracted from input devices that could be connected to an engagement tracking device and categorizing (320) engagement data includes identifying the predefined action associated with the received (314) and/or aggregate (316) input data and including the predefined action in the generated (318) engagement data. Other engagement categorization data, such as behavioral dimensions and/or contextual dimensions, can be utilized to categorize (320) engagement data as appropriate to the requirements of specific applications in accordance with embodiments of the invention. In many embodiments, engagement data is transmitted (322) to an engagement tracking server system for (further) categorization and analysis to determine trends within the engagement data.

Although a specific process for tracking interactions with displayed content where the content is a HTML web page is described above with respect to FIG. 3, any number of processes for tracking engagement with content, including content that is not a HTML web page, can be utilized in accordance with embodiments of the invention. Processes for identifying engagement trends in accordance with embodiments of the invention are discussed below.

### Identifying Engagement Trends

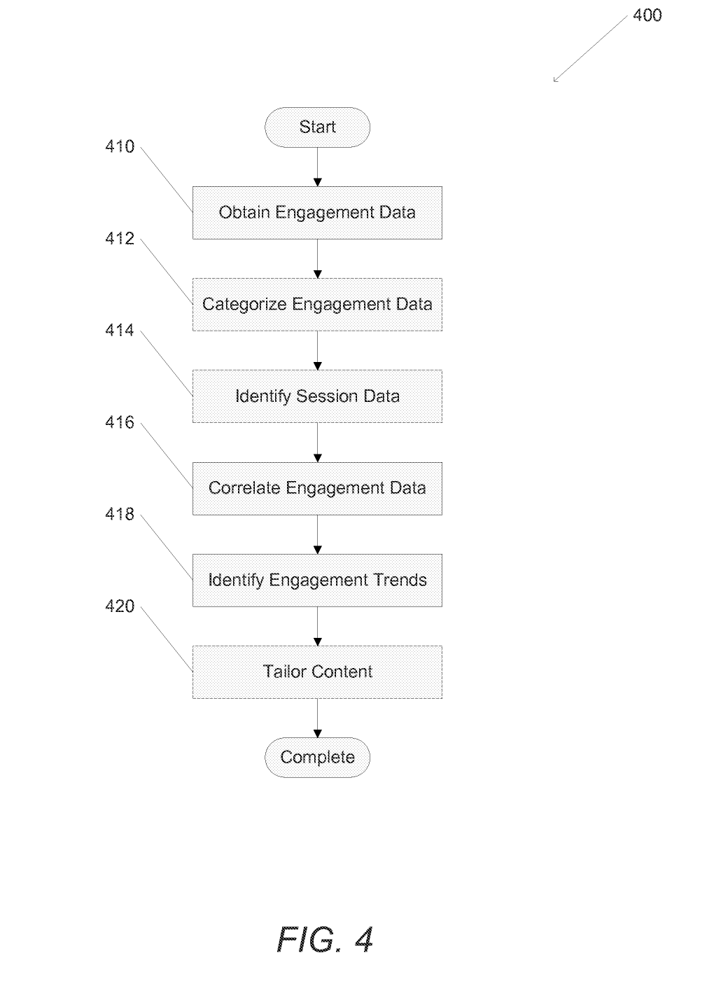

Based on engagement with content, trends and other performance data can be determined with respect to how users consume content. These trends can be utilized to improve the content and the presentation of that content to improve engagement with the content. Likewise, trends can also indicate what content and/or content presentations could better encourage engagement with the content and provide insights into how to improve engagement with content. Engagement tracking server systems and/or engagement tracking devices in accordance with embodiments of the invention are configured to analyze engagement data to identify trends and other performance data related to the interactions with one or more pieces of content. A process for identifying engagement trends within one or more pieces of engagement data in accordance with embodiments of the invention is illustrated in FIG. 4. The process 400 includes obtaining (410) engagement data. In several embodiments, engagement data is categorized (412). In a number of embodiments, session data is identified (414). Engagement data is correlated (416). Engagement trends are identified (418). In a variety of embodiments, content is tailored (420).

In several embodiments, engagement data is obtained (410) from one or more engagement tracking devices. In a number of embodiments, engagement data is categorized (412) based on the type of input identified in the engagement data. Categories of input include, but are not limited to, reading content, writing text, commenting on a piece of content, viewing video data, viewing image data, listening to audio data, sharing content, navigating to associated pieces of content, and closing the content. In many embodiments, engagement data is categorized (412) based on the content and/or the activity zone(s) identified in the engagement data. In a variety of embodiments, engagement data is categorized (412) based on the timestamp associated with the engagement data. Furthermore, engagement data can be categorized (412) based on a variety of properties, including types of input, behavioral dimensions, and/or contextual dimensions, not specifically described above as appropriate to the requirements of specific applications in accordance with embodiments of the invention.

In many embodiments, session data is identified (414) by associating multiple pieces of engagement data. Identifying (414) session data can be based on a variety of factors, such as the pieces of content being interacted within the pieces of engagement data, the web site associated with the pieces of content being interacted within the pieces of engagement data, the engagement tracking device providing the pieces of engagement data, and/or the time associated with the pieces of engagement data. Other factors can be utilized to identify (414) session data associating multiple pieces of engagement data as appropriate to the requirements of specific applications in accordance with embodiments of the invention. In a number of embodiments, correlating (416) engagement data includes associating pieces of engagement from different engagement tracking devices having different capabilities but performing similar functions with respect to activity zones. For example, an engagement tracking device including a touchscreen will provide touch-based input data in its engagement data, while an engagement tracking device including a mouse will include mouse-based input data in its engagement data. However, this touch-based input data and the mouse-based input data, when applied to similar activity zones within pieces of content, may be correlated (416) and utilized to identify (418) engagement trends. In several embodiments, identifying (418) engagement trends includes analyzing multiple pieces of engagement data and computing data regarding the interactions with activity zones described in the pieces of engagement data. In a variety of embodiments, the identified (418) engagement trends are determined based on pieces of engagement data associated with the same identified (414) session data and/or correlated (416) pieces of engagement data. In many embodiments, engagement trends are identified (418) using pieces of engagement data having similar activity zones in a variety of pieces of content. In a number of embodiments, identifying (418) engagement trends is based on the capabilities of the one or more engagement tracking device associated with the pieces of engagement data. Other processes for identifying (418) engagement trends using pieces of engagement data can be utilized as appropriate to the requirements of specific applications in accordance with embodiments of the invention. In a variety of embodiments, identifying (418) engagement trends can be performed by combining the engagement data with a variety of data sets and identifying trends in the combined data. Many data sets, including advertising data and browsing history data, can be utilized as appropriate to the requirements of specific applications in accordance with embodiments of the invention.

In a number of embodiments, the identified (418) engagement trends are used to tailor (420) content and/or activity zones associated with the content that is obtained by engagement tracking devices. In many embodiments, a user profile is maintained based on the obtained (410) engagement data and/or the identified (418) engagement trends that is utilized to tailor (420) content obtained by engagement tracking devices associated with the user profile. In a variety of embodiments, the user profile also includes a variety of other tracked data, such as advertising data and/or browsing data, that is correlated with the engagement data and/or engagement trends in the user profile to aid in the tailoring (420) of content. Content can be tailored (420) within a single browsing session and/or across a variety of browsing sessions associated with the user profile. For example, if a user profile indicates greater engagement with a first type of activity zone than a second type of activity zone (and/or a particular type of content within the activity zones), the content obtained by an engagement tracking device associated with the user profile can be tailored (420) to include the first type of activity zone rather than the second type of activity zone. Likewise, the content can be tailored (420) based on the user profile and the capabilities of the engagement tracking device as the identified (418) engagement trends can indicate that particular activity zones are more effective on one type of engagement tracking device than another for the same content. Other techniques can be utilized to tailor (420) content based on identified (418) engagement trends and/or obtained (410) engagement data as appropriate to the requirements of specific applications in accordance with embodiments of the invention.

A specific process for identifying engagement trends is described above with respect to FIG. 4; however, any number of processes for determining engagement data across a variety of sessions, including those that are performed using an engagement tracking device instead of an engagement tracking server system, can be utilized in accordance with embodiments of the invention.

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. An engagement tracking device, comprising:
a processor;
a memory configured to store an engagement tracking application; and
content storage configured to store content, where the content comprises data defining one or more activity zones within the content;
wherein the engagement tracking application configures the processor to:
display the content via a display device configured to display content, where the displayed content comprises one or more activity zones;
receive input data based on user input received via an input device configured to receive user input, where the input data is associated with one or more activity zones within the content;
generate engagement data based on the received input data, where the engagement data includes the received input data and identified the associated activity zone; and
transmit the engagement data to an engagement processing server system as the engagement data is generated.

2. The system of claim 1, wherein the engagement processing server system is configured to:
obtain a plurality of pieces engagement data from at least one engagement tracking device;
categorize a portion of the pieces of engagement data based on the received input data and the associated activity zone within the pieces of engagement data; and
identify engagement trends within the pieces of engagement data based on the categorized portion of the pieces of engagement data.

3. The system of claim 2, wherein the engagement processing server system is further configured to:
identify session data for a portion of the pieces of engagement data, where the session data identifies the portion of the pieces of engagement data as being related across a browsing session; and
identify engagement trends based on the categorized portion of the pieces of engagement data and the session data.

4. The system of claim 2, wherein the engagement processing server system is further configured to correlate a portion of the pieces of engagement data, where the correlated pieces of engagement data include different pieces of received input data that are determined to be similar based on the engagement tracking device receiving the input data.

5. The system of claim 1, wherein the engagement tracking application further configures the processor to:
aggregate a plurality of pieces of received input data, where the plurality of pieces of received input data are identified as being part of the same interaction with an activity zone; and
generate a piece of engagement data based on the aggregated input data.

6. The system of claim 1, wherein:
the input data further comprises a timestamp indicating the time associated with the receipt of the input data; and
the generated engagement data further comprises the timestamp.

7. The system of claim 6, wherein the engagement tracking application further configures the processor to categorize the engagement data based on the received input data, the activity zone associated with the input data, and the timestamp.

8. The system of claim 6, wherein the engagement tracking application further configures the processor to aggregate the input data based on the timestamp associated with the input data.

9. The system of claim 1, wherein the engagement tracking application further configures the processor to display the content based on the capabilities of the engagement tracking device.

10. The system of claim 1, wherein the engagement tracking application further configures the processor to categorize the engagement data based on engagement categorization data, where the engagement categorization data comprises a predefined set of activity zones associated with a predefined set of input data.

11. A method for tracking engagement with content, comprising:
displaying content using an engagement tracking device, where the displayed content comprises one or more activity zones;
receiving input data based on user input using the engagement tracking device, where the input data is associated with one or more activity zones within the content;
generating engagement data based on the received input data using the engagement tracking device, where the engagement data includes the received input data and identified the associated activity zone; and
transmitting the engagement data to an engagement processing server system as the engagement data is generated using the engagement tracking device.

12. The method of claim 11, wherein the engagement processing server system is configured to:
obtain a plurality of pieces engagement data from at least one engagement tracking device;
categorize a portion of the pieces of engagement data based on the received input data and the associated activity zone within the pieces of engagement data; and
identify engagement trends within the pieces of engagement data based on the categorized portion of the pieces of engagement data.

13. The method of claim 12, wherein the engagement processing server system is further configured to:
identify session data for a portion of the pieces of engagement data, where the session data identifies the portion of the pieces of engagement data as being related across a browsing session; and
identify engagement trends based on the categorized portion of the pieces of engagement data and the session data.

14. The method of claim 12, wherein the engagement processing server system is further configured to correlate a portion of the pieces of engagement data, where the correlated pieces of engagement data include different pieces of received input data that are determined to be similar based on the engagement tracking device receiving the input data.

15. The method of claim 11, further comprising:
aggregating a plurality of pieces of received input data using the engagement tracking device, where the plurality of pieces of received input data are identified as being part of the same interaction with an activity zone; and
generating a piece of engagement data based on the aggregated input data using the engagement tracking device.

16. The method of claim 11, wherein:
the input data further comprises a timestamp indicating the time associated with the receipt of the input data; and
the generated engagement data further comprises the timestamp.

17. The method of claim 16, further comprising categorizing the engagement data based on the received input data, the activity zone associated with the input data, and the timestamp using the engagement tracking device.

18. The method of claim 16, further comprising aggregating the input data based on the timestamp associated with the input data using the engagement tracking device.

19. The method of claim 11, further comprising displaying the content based on the capabilities of the engagement tracking device using the engagement tracking device.

20. The method of claim 11, further comprising categorizing the engagement data based on engagement categorization data using the engagement tracking device, where the engagement categorization data comprises a predefined set of activity zones associated with a predefined set of input data.
